(19) United States
(12) Patent Application Publication
(10) Pub. No.: US 2004/0162794 A1
(43) Pub. Date: Aug. 19, 2004

(54) Storage method and apparatus for genetic algorithm analysis

(76) Inventors: J. Barry Shackleford, Portola Valley, CA (US); Motoo Tanaka, Tokyo (JP)

Correspondence Address: HEWLETT-PACKARD COMPANY, Intellectual Property Administration, P.O. Box 272400, Fort Collins, CO, 80527-2400, US

(21) Appl. No.: 10/367,563

(22) Filed: Feb. 14, 2003

(51) Int. Cl. G06F 15/18; G06N 3/12; G06N 3/00

(52) U.S. Cl. 706/13

(57) ABSTRACT

A method and apparatus is used to organize aspects of electronic chromosomes for use in genetic algorithm (GA) analysis. The organization operations include receiving one or more elements for composing into an electronic chromosome analyzed using a genetic algorithm, ordering each of the one or more elements into an element sequence as determined by a fitness function, selecting a binary number sequence having a single-bit difference between each pair of adjacent binary numbers, and sequentially associating each of the one or more elements in the element sequence with a binary number in accordance with the binary number sequence.

### BACKGROUND OF THE INVENTION

The present invention relates to the use of genetic algorithms (GA) as a solution methodology to various computation driven problems.

GA uses an electronic chromosome to represent a potential answer to a problem being solved. The electronic chromosome is typically a binary string of “0s” and “1s” that identifies each electronic chromosome used by the GA analysis. In some cases, the electronic chromosome is further divided into subfields containing smaller groups of binary strings representing one or more elements used to create the electronic chromosome. For example, an electronic chromosome representing a protein sequence may be divided into a series of subfields corresponding to one or more amino acids making up the protein sequence.

During GA analysis, a fitness function designed to solve the problem is applied to one or more electronic chromosomes. The fitness function is designed to select an electronic chromosome with particular features and characteristics likely to solve the problem being investigated. In some cases, this fitness function may attempt to minimize the atomic weight or overall weight of a substance.

Moreover, a mutation operation causes one or more bits in the electronic chromosome to change with a certain low-probability. This mutation operation is important as it helps the GA analysis converge upon a solution more rapidly. In practice, if mutation occurs at all it generally only occurs on one-bit in the electronic chromosome or subfield because of the low-probability function being applied (i.e., generally between 1% to 2%).

Unfortunately, the organization of the elements may determine the effect of this important mutation operation on the electronic chromosome. Typical conventional organizational methods assign binary numbers to the subfields randomly, alphabetically, or in accordance with an ascending or descending characteristics inherent to the elements found in the subfields. For example, an increasing atomic weight of an element could be used to assign binary addresses to an element. Typically, the sequence of binary addresses assigned to the sequence of elements follows the conventional binary addressing methods. The first five elements in a sixteen element sequence of elements may use the binary sequence of: 0000, 0001, 0010, 0011, 0100, and 0101.

Under these circumstances, a single-bit mutation tends to favor some elements and disfavor other elements during GA analysis. This tends to prevent the GA analysis from exploring certain elements and using them as possible solutions in the subfields of the electronic chromosome. Meanwhile, other elements that may not best solve the problem may tend to occupy certain subfields of the electronic chromosome more often. For example, a single-bit mutation made on binary string “0011” cannot become the next binary string “0100” in the sequence without multiple-bit mutations. Conversely, a single-bit mutation on “0100” readily becomes “0101” and does represent the adjacent element in the sequence of elements. To overcome this bias, the address and elements representing subfields and other portions in an electronic chromosome need to be arranged differently.

### BRIEF DESCRIPTION OF THE DRAWINGS

FIG. 1 is a flow chart diagram of the operations for performing genetic algorithm (GA) analysis in accordance with one implementation of the present invention;

FIG. 2 is a block diagram illustrating both the cross-over operation between parent chromosomes and the mutation operation on a child chromosome;

FIG. 3 is a conventional table listing a set of amino acids for a protein sequencing problem;

FIG. 4 is a block diagram illustrating the problems associated with using a set of elements in the conventional table for GA analysis;

FIG. 5 provides a flowchart diagram of the operations performed on the elements used in a GA analysis;

FIG. 6 is a block diagram illustrating the effect of mutation on electronic chromosomes organized in accordance with one implementation of the present invention;

FIG. 7 is a flowchart diagram of the operations for performing mutation on chromosomes and subfields organized in accordance with one implementation of the present invention; and

FIG. 8 is a block diagram of a system using in one implementation for performing the apparatus or methods of the present invention.

Like reference numbers and designations in the various drawings indicate like elements.

### DETAILED DESCRIPTION

Aspects of the present invention are advantageous in at least one or more of the following ways. A genetic algorithm will converge on an optimal solution more rapidly when the solution elements and electronic chromosomes are represented by a binary sequence in accordance with implementations of the present invention. Certain elements making up the electronic chromosome are not favored during the mutation process based upon their corresponding binary representation. For example, an amino acid (i.e., an element) that makes up a protein may have substantially the same probability of being selected due to mutation as another amino acid. In particular, the relationship between the solution elements and corresponding binary representation does not inherently inhibit or promote the selection of certain elements when a single-bit mutation occurs. Consequently, probabilistic single-bit mutations occurring on an electronic chromosome will not become trapped in a local optimum but instead will continue to search rapidly through the solution space for the optimal solution.

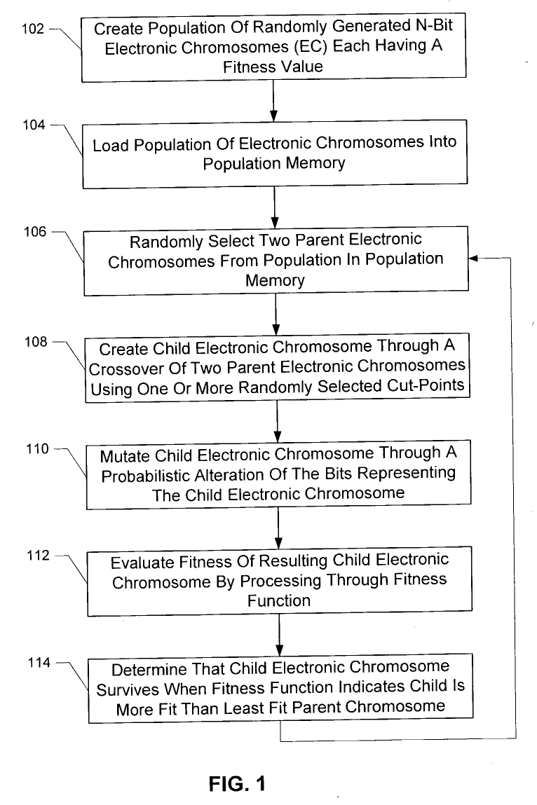

FIG. 1 is a flow chart diagram of the operations for performing genetic algorithm (GA) analysis in accordance with one implementation of the present invention. To begin GA analysis, a population of randomly generated n-bit electronic chromosomes (hereinafter referred to as chromosomes) is created and stored in population memory or other storage areas (102). Typically, the population memory also holds a fitness value corresponding each of the n-bit chromosomes in the population. Each chromosome is evaluated by a fitness function and assigned a fitness value based on how well the chromosome appears to solve the problem being analyzed. Moreover, the fitness value determines which chromosomes will be kept in population memory and, eventually, the one that solves the problem being analyzed most optimally.

The population memory is loaded with random n-bit binary patterns representing the chromosomes and corresponding m-bit fitness values assigned to each chromosome and related to the problem being studied (104). Two of the chromosomes are selected at random from among the chromosomes in the population memory as a pair of parent chromosomes (one for each parent) (106). The corresponding fitness value from each new parent is compared with the fitness value of the current least-fit chromosome. If the comparison indicates the fitness value of the newly selected parent chromosome is less fit, than the selected parent chromosome becomes identified as the least fit parent or chromosome within the population memory. When this occurs, the pointer to the least fit parent or chromosome is maintained to facilitate rapid access and subsequent comparisons as needed.

A probabilistic crossover operation between the first and second parent chromosomes produces a child chromosome (108). One or more randomly selected cut points on the pair of chromosomes delineate the sections of the parent chromosome to be used in the creation of the child chromosome. Both parent chromosomes are cut at the same cut point(s) and combined together to create the new child chromosome. For example, a single cut point produces a child chromosome composed of left-cut portion of a first parent chromosome and the right-cut portion of a second parent chromosome.

While one implementation of the present invention uses a single cut-point, it is also possible that multiple cut-points are selected and used in creating the child chromosome. Further, it is also possible that no cut-point is selected in which case one parent chromosome is copied and used directly to create the new child chromosome. It should be appreciated that both location of the cut-point(s) and the decision to perform the cross-over occur probabilistically and are not predetermined.

The resultant child chromosome is mutated through a probabilistic alteration of the bits representing the child chromosome (110). In one implementation, a low-probability of 1 per-cent per bit is selected as the likelihood that a bit value will be mutated into another bit value. All bits have the same independent chance of mutation, so multiple bit changes in an n-bit chromosome are possible but less likely than a single-bit mutation. Typically, each bit in the child chromosome is mutated by inverting 0s to 1s and vice versa.

After the mutation operation, the child chromosome is evaluated and processed by a fitness function (112). Each fitness function is designed to solve different problems within the GA analysis framework and can be implemented in software, hardware, firmware, combinations thereof, and may include Very Large Scale Integration (VLSI) or Field Programmable Gate Array (FPGA) technologies, for example. To solve a new problem, a different fitness function can be designed and implemented within substantially the same GA analysis framework described herein. The fitness function processes the child chromosome and produces a fitness value indicating of how well the particular child chromosome solves the given problem.

In one implementation, a fitness function can be created to identify a particular amino acid sequence used in a protein. Each amino acid is assigned a binary code and identified as a possible solution element for the fitness function to try. Combinations of the amino acids are put together as a series of subfields in an electronic chromosome. The electronic chromosomes representing various protein sequences are processed by the fitness function and assigned a fitness value according to specific criteria which could include, for example, minimizing the atomic weight of the amino acids used by the protein.

The child chromosome and the corresponding fitness value are used to determine whether the child chromosome survives and potentially replaces a parent chromosome in the population memory (114). The fitness value associated with the child chromosome is compared with the fitness value corresponding to the least fit parent chromosome in the current population memory to determine if the child chromosome survives. If the survival comparison indicates the child chromosome is more fit than the least-fit parent chromosome, the child chromosome replaces the chromosome in the population memory corresponding to the least-fit parent chromosome. By repeating this process the solution quality of the problem being solved by the GA increases as well as the overall fitness of the population.

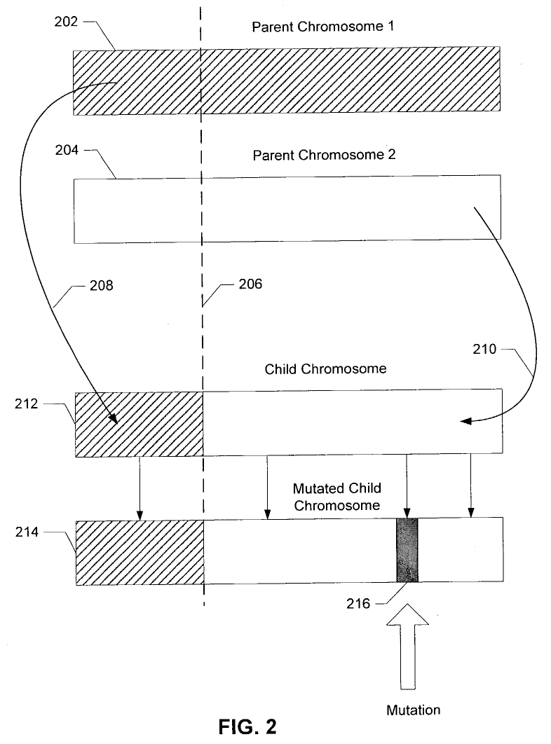

FIG. 2 is a block diagram illustrating both the cross-over operation between parent chromosomes and the mutation operation on a child chromosome. In this example, parent chromosome 202 and parent chromosome 204 are split along a single cut-point 206. Each parent contributes through cross-over operation 208 and cross-over operation 210 a portion of their electronic chromosome based on cut-point 206.

A child chromosome 212 having characteristics of both parent chromosomes is produced by these cross-over operations. Because the cut-point location is determined randomly, child chromosome 212 may have different proportions of each parent chromosome and is not limited to the combination illustrated herein. Multiple cut-points could also be used resulting in different portions of chromosomes from the parent chromosomes. A mutation operation applied bit-wise to child chromosome 212 causes a probabilistic variation in binary representation of child chromosome 212. Although the probability of mutation is often low, the mutation helps explore other potential solutions or combinations that may not have existed or been available in the existing population memory. Mutation assists in rapid convergence on an optimal solution without testing every possible combination. In the protein sequencing problem described previously, a mutation replaces a subfield of the child chromosome corresponding to one amino acid with another amino acid that may more closely solve the protein sequencing problem.

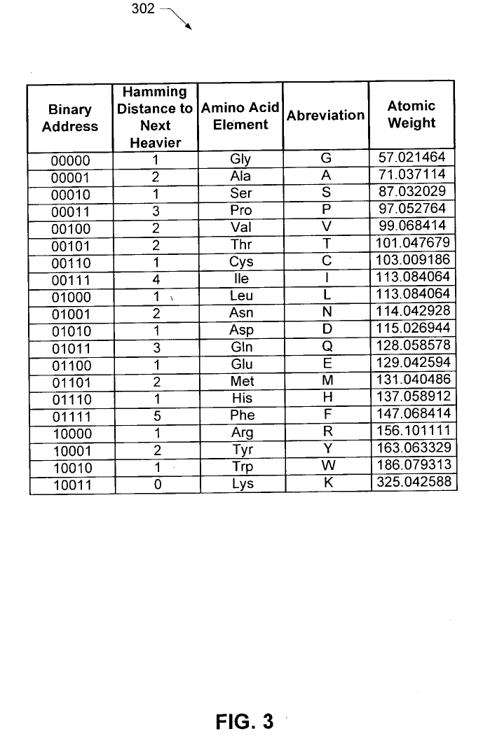

FIG. 3 is a conventional table 302 listing a set of amino acids for the protein sequencing problem. As will described later herein, implementations of the present invention have one or more advantages not provided by conventional table 302 when used in GA analysis. Here, conventional table 302 includes a binary address to identify the amino acid, a hamming distance to the next heavier amino acid, a short name (i.e., three letters) of each amino acid, an abbreviation of the amino acid (i.e., a single letter), and the corresponding atomic weight of each amino acid.

The GA systems using conventional table 302 arrange the binary numbering along with ascending/descending atomic weight of the respective amino acids. In table 302, the amino acids are arranged in increasing atomic weight and an increasing binary number sequence going from 00002 (“zero”) to 10011₂ (“nineteen”). In alternate conventional GA systems, amino acids may be arranged alphabetically as well in other various orders using the same binary number sequence. One or more binary addresses in table 302 correspond to different amino acids and when combined together in subfields represent the electronic chromosome used in GA analysis.

Mutation is an important computational mechanism for introducing different amino acids in the GA analysis that otherwise may not have been available directly from the parent chromosomes. In operation, these different amino acids are introduced by randomly changing bits in the binary address representation of the chromosome with a low probability. Each subfield portion of the binary address affected by the mutation specifies a different amino acid as the GA analysis attempts to converge on a solution. Because single-bit mutations are more likely to occur, next heavier amino acids in conventional table 302 with a Hamming distance closest to “1” are more likely to be selected through the mutation process.

For example, a single-bit mutation is more likely to select the “Ala”, “Pro”, “Ile”, “Leu”, “Gln”, “Met”, “Phe”, “Tyr”, and “Lys” amino acids than the other next heavier amino acids in conventional table 302. Adjacent lighter elements from these amino acids are distinguished from other elements in conventional table 302 as they are separated by only a hamming distance of 1. In contrast, a mutation applied to a chromosome with a subfield representing “Phe” is as unlikely to result in selecting the next heavier amino acid “Arg” as the probability of producing a five-bit mutation is improbable. Consequently, a mutation using conventional table 302 favors the selection of certain amino acids due to the organization of data in conventional table 302 rather than the ability to provide an optimal solution. This tends to limit the scope of solutions being explored during GA analysis and potentially delay convergence upon a more optimal solution.

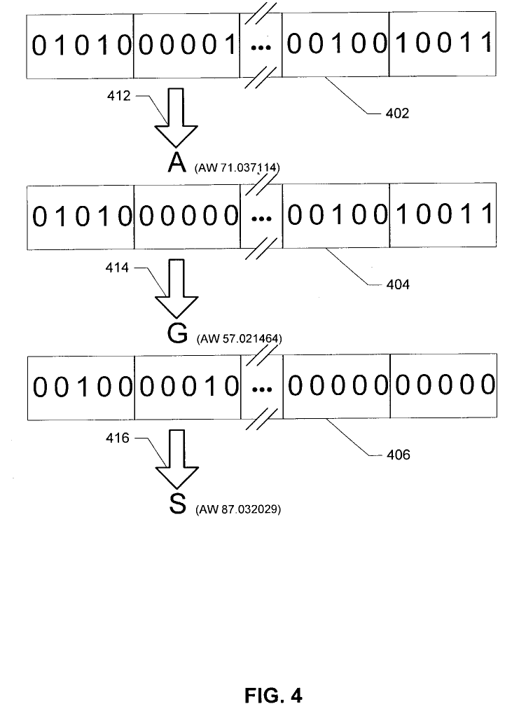

The problem associated with conventional table 302 and GA analysis is illustrated more specifically by the block diagram in FIG. 4. In this example, amino acid “Ala” in subfield 412 and electronic chromosome 402 requires mutation of multiple bits to get to the next heavier amino acid. Mutating only one-bit causes amino acid “Ala” to become a lower weight amino acid “Gly” as illustrated by subfield 414 in electronic chromosome 404. Electronic chromosome 406 and subfield 416 contains the next heavier amino acid “Ser” only when the second mutation occurs as illustrated. The lower probability of a two-bit mutation makes it less likely to select “Ser” as the next heavier amino acid and explore a wider range of solutions.

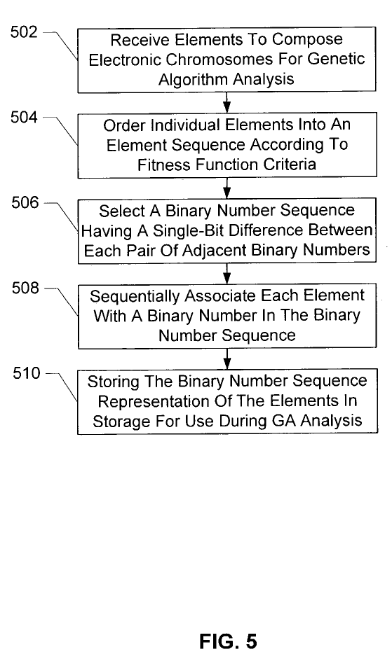

Implementations of the present invention reorganize the elements to better exploit GA analysis and improve convergence on a more optimal solution. FIG. 5 provides a flowchart diagram of the operations performed on the elements used in a GA analysis. Typically, this process is performed once when the table of elements is being organized for a particular fitness function and GA solution. Organizing the elements may be the responsibility of the party designing the fitness function or, if the GA analysis allows reorganizing the elements into different element sequences, by the party using the software to actually perform the GA analysis.

Initially, implementations of the present invention receive one or more elements for composing into various electronic chromosomes (502). For example, the one or more elements could include the amino acids used in the chromosomes of the protein sequencing problem previously described. Individual elements are ordered into an element sequence according to fitness function criteria (504). In one implementation, amino acids are arranged according to their increasing atomic weights to assist the fitness function identify a protein sequence with an optimum atomic weight. The next heavier amino acids are adjacent to each other and used to generate a fitness value for population memory entries.

The present invention identifies a binary number sequence having a single-bit difference between each pair of adjacent binary numbers (506). One implementation identifies a Grey Code address range with numbers in the sequence to cover the range of elements in the element sequence. The binary numbers in the Grey Code address range are sequentially associated with elements in the element sequence (508). In contrast with conventional solutions, adjacent elements in the element sequence are separated by binary numbers with a Hamming distance of only one. Sequencing elements in this manner helps even the probability of selecting the next element in the element sequence due to single-bit mutation.

As applied to the protein sequencing example previously described, a single-bit mutation of the amino acid “Ala” could result in selecting the next heavier amino acid “Ser” directly and without requiring any additional and less probable multiple bit mutations. The resulting sequence of elements and corresponding binary number sequence associated with the elements is then stored for use during GA analysis (510). Depending on the implementation, the binary number sequence and elements can be stored in a table, a database, or any other logical data structure appropriate for the particular solution. Further, the logical data structure can be stored in memory, NVRAM (non-volatile random access memory), ROM (read-only memory), disk storage, or any other physical storage medium as dictated by the GA system and implementation.

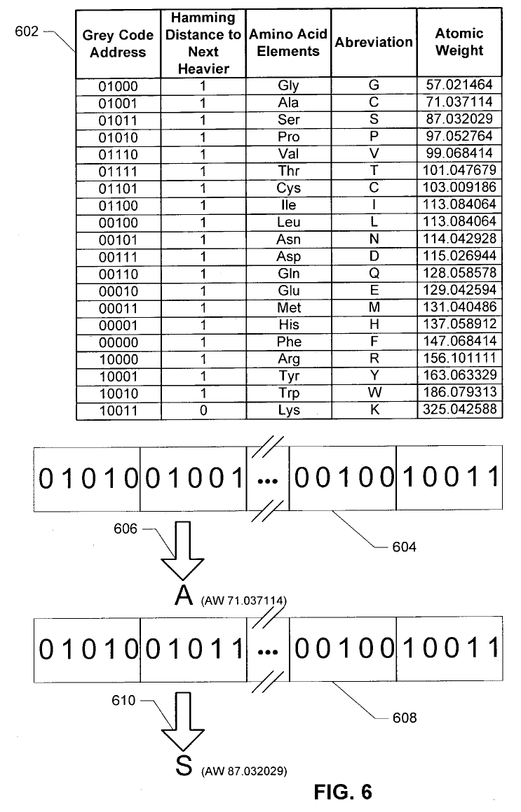

FIG. 6 is a block diagram illustrating the effect of mutation on electronic chromosomes organized in accordance with one implementation of the present invention. In FIG. 6, a table 602 includes an element sequence of amino acids used in GA analysis to solve the protein sequencing problem previously discussed. In this implementation, the amino acids are organized in increasing atomic weights and associated corresponding binary Grey Code addresses having a Hamming distance of 1 between adjacent entries. By organizing the sequence of elements in this manner, the GA analysis is more likely to explore the different available amino acids due to single-bit mutation and more rapidly converge upon an optimum solution.

For example, a chromosome 604 has a subfield 606 with a binary address from table 602 representing the amino acid “Ala”. If a single-bit mutation occurs on amino acid “Ala”, it is possible that “Ala” will be mutated into the next heavier amino acid “Ser” in the element sequence based on the organization of elements in table 602. As illustrated by table 602, similar advantageous results are also obtained when a single-bit mutation is applied to the other elements in table 602 organized in accordance with implementations of the present invention. Overall, the organization of elements in table 602 helps converge upon a optimal solution as the fitness function in this particular example optimizes overall weight of the protein sequence.

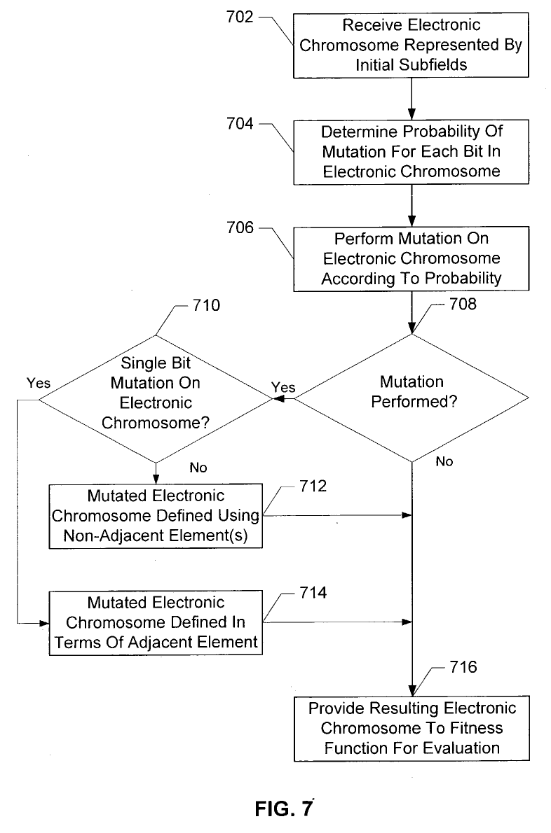

FIG. 7 is a flowchart diagram of the operations for performing mutation on chromosomes and subfields organized in accordance with one implementation of the present invention. During GA analysis, an electronic chromosome containing one or more subfields is received for processing (702). In one implementation, the electronic chromosome contains a number of subfields each corresponding to various amino acids useful in solving the protein sequencing problem as previously discussed (704). A probability function is used to determine whether the one or more bits in the chromosome should be mutated. The actual mutation operation generally involves inverting each bit from “1” to “0” or vice-versa with a low probability of, for example, 1%-2%. Other probabilities can also be used depending on the fitness function and GA analysis being performed.

If no mutation occurs, the electronic chromosome is provided directly to the fitness function for evaluation (716). Alternatively, if a single-bit mutation occurs on the electronic chromosome (710) then there is a likelihood that the subfield affected by the mutation may be defined in terms of an adjacent element in the element sequence. For example, performing a single-bit mutation on the “Ala” amino acid in table 602 represented by the binary address “01001” in FIG. 2 may result in the subfield holding binary address “01011” representing the adjacent amino acid of “Ser”. This organization of elements in accordance with the present invention improves GA analysis as certain elements in the element sequence are not inherently favored or disfavored merely because of the addressing scheme.

While more unlikely, multiple-bit mutations of the chromosome may also occur and cause different subfields to hold different non-adjacent elements (712). For example, a two-bit mutation occurring on the “Ala” amino acid (“01001”) listed in table 602 in FIG. may cause the subfield to contain the binary address “01010” representing the “Pro” amino acid. Eventually, chromosomes having one-bit, two-bit, multiple-bit or no bits altered are provided to fitness function for evaluation.

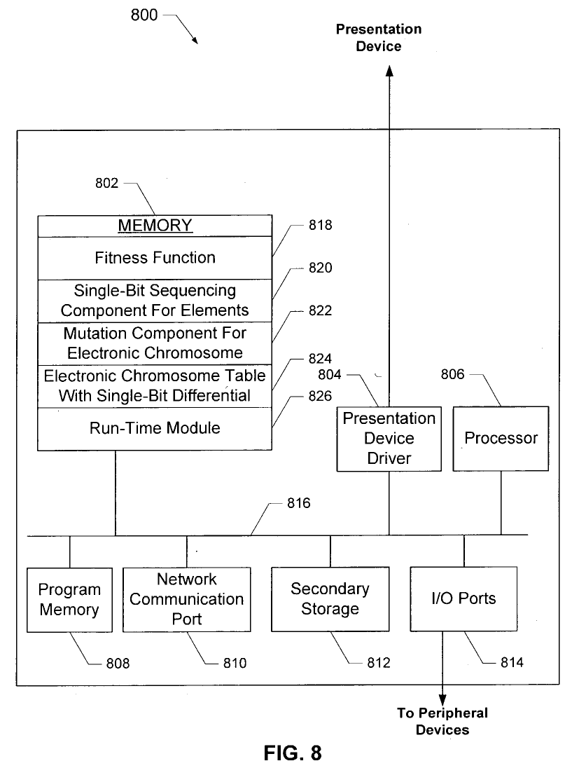

FIG. 8 is a block diagram of a system 800 used in one implementation for performing the apparatus or methods of the present invention. System 800 includes a memory 802 to hold executing programs (typically random access memory (RAM) or writable read-only memory (ROM) such as a flash ROM), a presentation device driver 804 capable of interfacing and driving a display or output device, a program memory 808 for holding drivers or other frequently used programs, a network communication port 810 for data communication, a secondary storage 812 with secondary storage controller, and input/output (I/O) ports 814 also with I/O controller operatively coupled together over a bus 816. The system 800 can be preprogrammed, in ROM, for example, using field-programmable gate array (FPGA) technology or it can be programmed (and reprogrammed) by loading a program from another source (for example, from a floppy disk, a CD-ROM, or another computer). Also, system 800 can be implemented using customized application specific integrated circuits (ASICs).

In one implementation, memory 802 includes a fitness function 818, a single-bit sequencing component for elements 820, a mutation component for electronic chromosomes 822, an electronic chromosome table 824, and a run-time module 826 that manages system resources used when processing one or more of the above components on system 800.

As previously described, fitness function 818 is designed to solve a particular problem using GA. In the previously described example, the fitness function uses amino acids in solving a protein sequencing problem however implementations of the present invention could also use different fitness functions and solve many different problems. Single-bit sequencing component for elements 820 assigns a sequence of addresses with a Hamming distance of 1 between adjacent addresses to a sequence of elements. In one implementation, a Grey Code binary numbering scheme is used to generate the sequence of addresses having the Hamming distance of 1 between adjacent addresses however alternate implementations may use a different numbering scheme with the same effective results.

Mutation component 822 uses a low-probability function to determine whether one or more bits in an electronic chromosome should be mutated. In accordance with implementations of the present invention, adjacent elements in an element sequence may be selected when a one-bit mutation of a chromosome occurs. Given the organizational scheme, the one-bit mutation has the potential of using each of the different elements in the element sequence stored in electronic chromosome table 824.

Electronic chromosome table with single-bit differential 824 is a table or other data structure used to hold the sequence of elements used by the GA analysis and the corresponding binary addresses used to address each of the elements. In one implementation, the table resembles table 602 in FIG. 6 when solving protein sequencing problems and with these particular amino acids.

While examples and implementations have been described, they should not serve to limit any aspect of the present invention. Accordingly, implementations of the invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of nonvolatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs.

While specific embodiments have been described herein for purposes of illustration, various modifications may be made without departing from the spirit and scope of the invention. Accordingly, the invention is not limited to the above-described implementations, but instead is defined by the appended claims in light of their full scope of equivalents.

What is claimed is:

1. A method of organizing aspects of electronic chromosomes as used in genetic algorithm analysis, comprising:
receiving one or more elements for composing into an electronic chromosome analyzed using a genetic algorithm;
ordering each of the one or more elements into an element sequence according as determined by a fitness function;
selecting a binary number sequence having a single-bit difference between each pair of adjacent binary numbers; and
sequentially associating each of the one or more elements in the element sequence with a binary number in accordance with the binary number sequence.

2. The method of claim 1 further comprising:
storing the one or more elements and corresponding binary number sequence in a storage area readily accessible by one or more operations associated with the genetic algorithm.

3. The method of claim 1 wherein the storage area is selected from a set of storage areas including: a database, a table, a heap, and an object-oriented class definition.

4. The method of claim 1 wherein the one or more elements each corresponds to different amino acids.

5. The method of claim 4 wherein the amino acids are selected from a set of amino acids including: Ala, Cys, Asp, Glu, Phe, Gly, His, He, Lys, Leu, Met, Asn, Pro, Gln, Arg, Scr, Thr, Val, Trp, or Tyr.

6. The method of claim 1 wherein the genetic algorithm is associated with analyzing one or more protein sequences.

7. The method of claim 1 wherein ordering the individual elements is performed in accordance with ascending or descending weights associated with each element.

8. The method of claim 7 wherein the weight of each element depends on the corresponding atomic weight.

9. The method of claim 1 wherein selecting the binary number sequence includes identifying a grey code sequence large enough to represent each of the one or more elements in the element sequence.

10. The method of claim 1 wherein each element in the binary number sequence has a Hamming distance of one from each of the adjacent elements.

11. The method of claim 9 wherein the grey code sequence includes a set of at least 20 binary numbers corresponding to at least 20 amino acids arranged in sequence according to their atomic weight.

12. A method of processing an electronic chromosome using a genetic algorithm, comprising:
receiving an electronic chromosome composed of one or more initial elements selected from an element sequence represented by a corresponding binary sequence having adjacent pairs of binary numbers differing by a single-bit;
determining a bit-wise probability of mutation for the electronic chromosome and underlying elements;
performing a mutation on the electronic chromosome and underlying elements depending on the bit-wise determination of probabilities; and
representing a mutated electronic chromosome in terms of an adjacent element in the element sequence when a single-bit mutation occurs.

13. The method of claim 12 further comprising:
representing a mutated electronic chromosome with one or more non-adjacent elements in the element sequence when more than a single-bit mutation of the electronic chromosome occurs.

14. The method of claim 12 further comprising:
providing the resulting electronic chromosome to a fitness function for evaluation.

15. The method of claim 12 wherein the one or more subfields used to compose the electronic chromosome each corresponds to different amino acids.

16. The method of claim 15 wherein the amino acids are selected from a set of amino acids including: Ala, Cys, Asp, Glu, Phe, Gly, His, He, Lys, Leu, Met, Asn, Pro, Gin, Arg, Scr, Thr, Val, Trp, or Tyr.

17. The method of claim 12 wherein the genetic algorithm is associated with analyzing one or more protein sequences.

18. The method of claim 12 wherein ordering of the element sequence is performed in accordance with increasing or decreasing a weight associated with each element.

19. The method of claim 18 wherein the ordering of each element in the element sequence is based on the atomic weight of each element.

20. The method of claim 12 wherein the binary number sequence utilizes a grey code sequence large enough to represent each of the one or more elements in the element sequence.

21. The method of claim 12 wherein the binary number sequence includes identifying a grey code sequence large enough to represent each of the one or more elements in the element sequence.

22. The method of claim 12 wherein each element in the binary number sequence has a Hamming distance of one from each of the adjacent elements.

23. The method of claim 21 wherein the grey code sequence includes a set of at least 20 binary numbers corresponding to at least 20 amino acids arranged in sequence according to their atomic weight.

24. A computer program product for organizing aspects of electronic chromosomes as used in genetic algorithm analysis, tangibly stored on a computer-readable medium, comprising instructions operable to cause a programmable processor to:
receive one or more elements for composing into an electronic chromosome analyzed using a genetic algorithm;
order each of the one or more elements into an element sequence according as determined by a fitness function;
select a binary number sequence having a single-bit difference between each pair of adjacent binary numbers; and
sequentially associate each of the one or more elements in the element sequence with a binary number in accordance with the binary number sequence.

25. A computer program product for processing an electronic chromosome using a genetic analysis algorithm, tangibly stored on a computer-readable medium, comprising instructions operable to cause a programmable processor to:
receive an electronic chromosome composed of one or more initial elements selected from an element sequence represented by a corresponding binary sequence having adjacent pairs of binary numbers differing by a single-bit;
determine a bit-wise probability of mutation for the electronic chromosome and underlying elements;
perform a mutation on the electronic chromosome and underlying elements depending on the bit-wise determination of probabilities; and
represent a mutated electronic chromosome in terms of an adjacent element in the element sequence when a single-bit mutation occurs.
